(19) United States
(12) Patent Application Publication
(10) Pub. No.: US 2023/0283634 A1
(43) Pub. Date: Sep. 7, 2023

(54) DETERMINING INTENT OF PHISHERS THROUGH ACTIVE ENGAGEMENT

(71) Applicant: INTERNATIONAL BUSINESS MACHINES CORPORATION, ARMONK, NY (US)

(72) Inventors: Shikhar Kwatra, San Jose, CA (US); Indervir Singh Banipal, Austin, TX (US); Charles Kenneth Flack, Marietta, GA (US); Seng Chai Gan, Ashburn, VA (US)

(21) Appl. No.: 17/649,830

(22) Filed: Feb. 3, 2022

(51) Int. Cl. H04L 9/40; G06N 3/04

(52) U.S. Cl. CPC H04L 63/1491; G06N 3/0454; H04L 63/1483

(57) ABSTRACT

A computer-implemented method, a computer system and a computer program product use artificial intelligence (AI) to extract information from a phisher. The method may include identifying a malicious email on a server. The malicious email comprises an attempt by the phisher to compromise a user. The method may also include generating an automated conversational agent that poses as the user. The method may further include transmitting a message to the phisher by the automated conversational agent. The message indicates that the user has been compromised. In addition, the method may include receiving a response from the phisher. Lastly, the method may include determining an intent of the phisher based on the response.

### BACKGROUND

Embodiments relate generally to the field of computer security, and more specifically, to preventing phishing attacks by using artificial intelligence (AI) to determine the intent of a phisher through active engagement that may convince the phisher that an attack was successful.

As the Internet may become more popular for everyday use and more commerce may flow online, the possibility may also be increased that network users may be deceived into providing personal information through a technique known as phishing. A common phishing practice may be to solicit users with an email or other communication that may include information that appears legitimate but may direct a user to a malicious or fraudulent source. The user may believe that they are conducting a normal business transaction or maintenance on an existing account but if the user interacts with the message, the user may be led to a website that aims to deceive users into giving over their personal information. The result of a multitude of interactions such as this may be compromised user data and severe harm to the reputation of legitimate business organizations. As such, legitimate organizations may have an incentive to identify the source of phishing attacks for the purpose of understanding the intent, or motive, of the attack or simply identify the attacker for the authorities to take further action.

### SUMMARY

An embodiment is directed to a computer-implemented method for using artificial intelligence (AI) to extract information from a phisher. The method may include identifying a malicious email on a server, where the malicious email may comprise an attempt by the phisher to compromise a user. The method may also include generating an automated conversational agent that poses as the user. The method may further include transmitting a message to the phisher by the automated conversational agent, where the message may indicate that the user has been compromised. In addition, the method may include receiving a response from the phisher. Lastly, the method may include determining an intent of the phisher based on the response.

In an embodiment, the method may include receiving personal data from the user. In this embodiment, the method may also include updating the automated conversational agent based on the personal data.

In another embodiment, a generative adversarial network (GAN) may be used to generate the automated conversational agent.

In a further embodiment, the method may include determining an effectiveness of the message that is transmitted by the automated conversational agent based on the response from the phisher. In this embodiment, the method may also include updating the automated conversational agent based on the effectiveness of the message.

In yet another embodiment, a reinforcement learning algorithm may be used to update the automated conversational agent based on the effectiveness of the message that is transmitted by the automated conversational agent.

In an embodiment, the method may include displaying the message that is transmitted by the automated conversational agent to an expert user. In this embodiment, the method may include receiving a recommendation from the expert user. Lastly, the method may include updating the effectiveness of the message based on the recommendation from the expert user.

In a further embodiment, a machine learning classification model that determines an intent of a participant in a conversation from transmissions of the participant may be used to determine the intent of the phisher.

In addition to a computer-implemented method, additional embodiments are directed to a system and a computer program product for using artificial intelligence (AI) to extract data by engaging a phisher in conversation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that uses artificial intelligence (AI) to extract data by engaging a phisher in conversation according to an embodiment.

FIG. 3 depicts a cloud computing environment according to an embodiment.

FIG. 4 depicts abstraction model layers according to an embodiment.

### DETAILED DESCRIPTION

As more and more legitimate business may be conducted through the Internet, phishing emails continue to present a problem for many users. As attackers get better, malicious emails look more and more indistinguishable from legitimate ones. For example, the email may have the appearance of legitimacy by including company logos or other images that correspond to the organization they are attempting to impersonate. The image may contain an embedded link, which the user believes will take them to the correct site but will, in fact, direct them to the attacker’s site.

Phishing represents a fraudulent technique employed to obtain confidential transaction information, e.g., username, password, financial information, credit card information, from computer users for misuse. In phishing, the phisher employs a phishing server to send an apparently official electronic communication (such as an official looking email) to a user. For example, if a phisher wishes to obtain confidential information to access a user’s bank account, the email may appear to come from a bank email address and contain official-looking logos and language to deceive the user into believing that the email is legitimate.

Further, the phisher’s email may include language urging users to access the bank’s website to verify some information or to confirm a transaction. The email may also include a link attached for the user to supposedly access the bank’s website. However, when the user clicks on the link, the user may be taken instead to a fraudulent website set up in advance by the phisher. The fraudulent website, i.e., the phishing website, would then ask for confidential information from the user. Since the user may have been told in advance that the purpose of clicking on the link is to verify some account information or to confirm a transaction, many users would unquestioningly enter the requested information. Once the confidential information is collected by the phisher, the phisher can then use the information to commit fraud. For instance, money may be withdrawn from the bank account or goods purchased with the user’s credit card information.

One way that phishing attacks may be stopped involves alert and knowledgeable users. Because phishing attacks may actually divert users to a website address that is different from an intended legitimate website address, a user may be able to spot the difference in the website addresses and may refuse to furnish the sensitive information. For instance, if the user sees an address such as “http://218.246.224.203/icons/cgi-bin/xyzbank/login.php” in the URL address bar of their web browser, that user may realize the address is different from the usual “http://www.xyzbank.com/us/cgi-bin/login.php”. However, users may not be sophisticated or always vigilant against such phishing attempts and relying on users to stay on guard against phishing attempts may be an inadequate response to phishing attacks.

URL filtering techniques may also be employed to detect whether a particular website is a known phishing website. For example, if a website with a certain IP address is known to be a phishing website, any attempt to access that website by a user, such as clicking on an image with an embedded link, may be instantly denied. However, URL filtering may require prior knowledge of the phishing website, with a focus on specifically identifying suspicious links to determine whether the address or URL in the link belongs to a known malicious site based upon a disallow list. In addition to the overhead and trouble of maintaining such a disallow list, if a phisher sets up a new website for the purpose of conducting phishing attacks, and the new website has a new address that has not yet been detected as a phishing website, URL filtering may not be able to detect this newly set up website as a phishing website. As a result, malicious sites may not show up on a disallow list until they have already caused damage that has been reported.

It may be useful to learn the intent or purpose of a phisher in order to prevent attacks on users and, in doing so, it may be possible to learn specific incriminating data about a phisher that may be used to identify a phisher and assist authorities with preventing future attacks on consumers and businesses that may utilize the public Internet for commerce. To accomplish this goal, it may be advantageous to turn the techniques of the phisher around with artificial intelligence (AI). That is, a conversational agent may be generated that poses as a user, i.e., impersonates a user, that may have been the victim of a phishing attack and may engage in an exchange with the phisher independent of the user, using a persona that may be programmed to simulate the actual human user, and make the phisher believe that the attack was successful. Such an agent may operate independently of the user themselves and may not have access to any of the sensitive information that the phisher may attempt to receive but if the phisher believes that the information is forthcoming, the phisher may themselves reveal information relevant to the phisher’s intent or perhaps provide data that may be used to specifically identify the phisher that may be forwarded to official authorities.

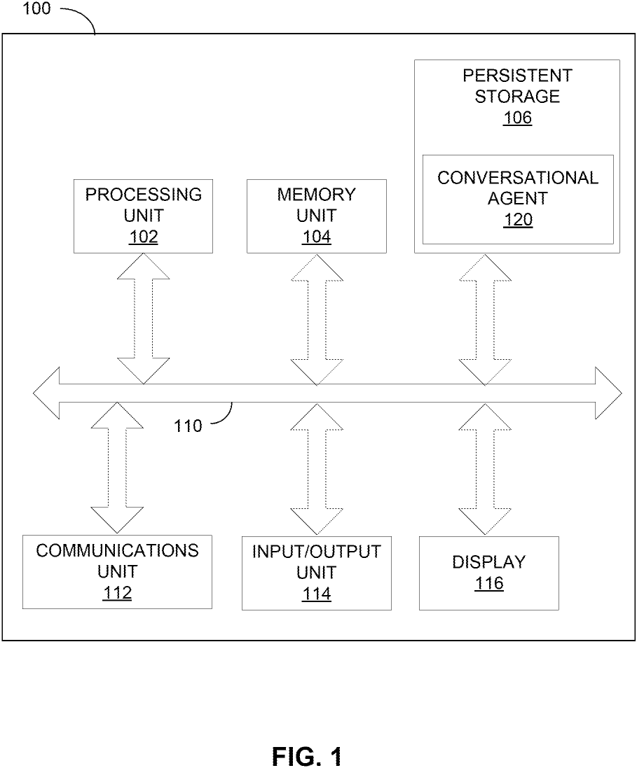

Referring now to FIG. 1, there is shown a block diagram illustrating a computer system 100 in accordance with an embodiment. It should be appreciated that FIG. 1 provides only an illustration of one implementation and does not imply any limitations with regard to the environments in which different embodiments may be implemented. Many modifications to the depicted environments may be made based on design and implementation requirements.

As shown, a computer system 100 includes a processor unit 102, a memory unit 104, a persistent storage 106, a communications unit 112, an input/output unit 114, a display 116, and a system bus 110. Computer programs such as the conversational agent 120 may be stored in the persistent storage 106 until they are needed for execution, at which time the programs are brought into the memory unit 104 so that they can be directly accessed by the processor unit 102. The processor unit 102 selects a part of memory unit 104 to read and/or write by using an address that the processor unit 102 gives to memory unit 104 along with a request to read and/or write. Usually, the reading and interpretation of an encoded instruction at an address causes the processor unit 102 to fetch a subsequent instruction, either at a subsequent address or some other address. The processor unit 102, memory unit 104, persistent storage 106, communications unit 112, input/output unit 114, and display 116 interface with each other through the system bus 110.

Examples of computing systems, environments, and/or configurations that may be represented by the data processing system 100 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

Each computing system 100 may also include a communications unit 112 such as TCP/IP adapter cards, wireless Wi-Fi interface cards, or 3G or 4G wireless interface cards or other wired or wireless communication links. Communication between mobile devices may be accomplished via a network and respective network adapters or communication units 112. In such an instance, the communication network may be any type of network configured to provide for data or any other type of electronic communication. For example, the network may include a local area network (LAN), a wide area network (WAN), a virtual private network (VPN), a mobile or cellular telephone network, the Internet, or any other electronic communication system. The network may use a communication protocol, such as the transmission control protocol (TCP), the user datagram protocol (UDP), the internet protocol (IP), the real-time transport protocol (RTP) the Hyper Text Transport Protocol (HTTP), or a combination thereof.

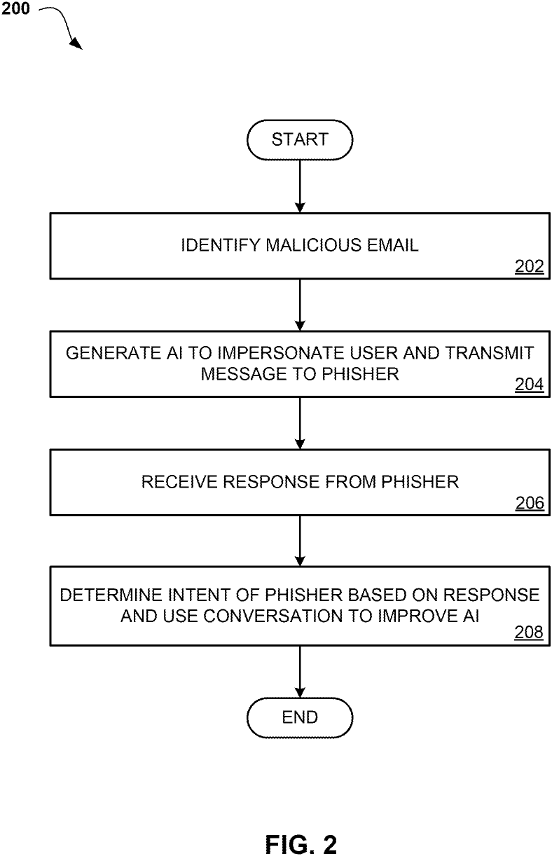

Referring to FIG. 2, an operational flowchart illustrating a process 200 that uses artificial intelligence (AI) to extract data by engaging a phisher in conversation is depicted according to at least one embodiment. At 202, malicious emails may be identified. One of ordinary skill in the art may recognize that the identification of malicious emails may be accomplished in several ways, perhaps manually by a user that may have received an email and may have marked the email as malicious or may have reported the email to an authority within an organization to which the user belongs, such as an information technology (IT) professional at a workplace, or perhaps to a law enforcement agency or other outside official authority that may conduct further investigation into the legitimacy of the email, e.g., determine whether the email is actually malicious. Another method of identification may be an automatic filter that may have the ability to detect suspicious emails, such as a sender address with a nonstandard format or a subject line or other text that may have irregular grammar or punctuation. Suspicious emails may also have attached or embedded images that may not be standard, or images that contain links that may be suspicious. Such a filter may also flag an email simply if the email contains any image or link within the body of the text. Whether manual or automatic identification is used in 202, what is presented to the remainder of process 200 may be an email that is identified as malicious and contains a source and destination address for the process 200 to use. Once an email is identified as malicious at 202, further background details about the email may be gathered, such as a possible intent of the sender or specific data about the source of the email that may allow for the authorities to identify the sender and possibly impose penalties on the sender.

At 204, a conversational agent 120 may be generated for the purpose of sending a communication to the source of the malicious email. The conversational agent 120 may be programmed to replicate a user for the purpose of convincing the phisher that an attack was successful and the user wishes to engage the phisher in a conversation. To achieve this level of engagement, the conversational agent 120 may politely interrogate the phisher using information that may be gathered from the malicious email that has been identified and also by gathering information about the user that may be used to poses as, i.e., impersonate, the user. For example, if a user has a public profile that is available, the agent may collect specific details from the profile to make the agent more convincing. Another example may be collecting details about the user that may be available exclusively within an organization that received the malicious email and the conversational agent 120 may be programmed with those details to improve the impersonation of the user.

In addition to automated methods of gathering details to create a persona matching the user, the user may be given an opportunity to share a limited amount of data, in an opt-in fashion, so that the shared data can be used in creating the conversational agent 120 and convincing the phisher that an actual user is talking and falling into the trap. Such data may be faked by the user, but even if actual data were used, the user may retain full control over the data. This data may be as trivial as information such as name and address, which may already be public through various other means.

The intent of the conversational agent 120 is to engage with the phisher while not involving the actual user. In fact, the actual user may not know that the interaction with the phisher may be occurring. To further improve the impersonation of the user and convince the phisher that they should engage with the agent, a tone of voice may be adopted for the agent that may be agreeable and subject to being adjusted as a conversation with a phisher may be started and maintained. Further refinement of the conversational agent is discussed below once the phisher has responded to initial messages.

At 206, a response may be received by the conversational agent 120 from the phisher at the source of the malicious email for the purpose of extracting data from the phisher that may be used to determine the intent of the phisher or possibly identify the phisher. Such data may include direct statements of intent but may also include statements that may be analyzed for tone of voice or other indirect words or phrases that indicate intent.

At 208, the intent of the phisher may be determined from the data that may be included in the response. As mentioned above, the response may also be used to improve the programming of the conversational agent 120 and its impersonation of the user.

In an embodiment, a supervised machine learning classification model may be trained to predict the effectiveness of a message transmitted by the conversational agent 120. For instance, if the phisher indicates in a response that the phisher does not believe that the output of the conversational agent 120 was possibly coming from the human user being targeted by the phisher, this determination may result in a low effectiveness and cause the programming of the conversational agent 120 to be adjusted to make the agent more convincing, such as changing the tone of voice to make the agent more agreeable to the phisher or perhaps including some user details that may make the conversational agent 120 more convincing. In this instance, the analysis of the response from the phisher may be classified as effective or not. One or more of the following machine learning algorithms may be used: logistic regression, naive Bayes, support vector machines, deep neural networks, random forest, decision tree, gradient-boosted tree, multilayer perceptron, and one-vs-rest. In an embodiment, an ensemble machine learning technique may be employed that uses multiple machine learning algorithms together to assure better prediction when compared with the prediction of a single machine learning algorithm. In this embodiment, training data for the model may include several sample responses from a variety of users expressing whether the response from an agent is convincing to them and therefore effective. The training data may be collected from a single example user or a group of users, with user consent required prior to collection of any data from human users. The classification results may be stored in a database so that the data is most current, and the output would always be up to date.

In another embodiment, the training data for determining effectiveness of agent responses may include presenting output of the conversational agent 120 to one or more experts, a group of actual human users expert in the area of phishing through conversational AI. These experts may then indicate a rating of the effectiveness of the response and the programming of the conversational agent 120 may be adjusted, or updated, based on how the responses are rated by the expert users. Based on this internal feedback in conjunction with the GAN model, the conversational agent 120 may get better over time with minimal ground truth since this model is generative in nature.

As mentioned above, the response from the phisher in the course of the conversation may be checked for any data that indicates an intent or identification of the phisher. Such data may be used to classify a conversation, and therefore also a phisher, by intent. Such a classification may be accomplished with a supervised machine learning model such as that used in the prediction of effectiveness that has been mentioned above and may result in the storing of a source address along with the determination of intent in a database. Understanding of the intent of the phisher, as mentioned above, may assist with preventing future attacks. In addition, if the conversational agent 120 is successful in extracting specific data that may identify the phisher, this data may also be stored and possibly transmitted to official authorities, which may also prevent future attacks on the users that may be connected to the conversational agent 120.

To refine the impersonation of the user and also convince the phisher to continue with a conversation, a generative adversarial network (GAN) may be used. In a GAN architecture, two models may be used: a generator model that may output new plausible responses and tone of voice or other attributes and a discriminator model that may classify those responses as convincing or not. In such an architecture, the two models may be trained simultaneously in an adversarial fashion such that the generator seeks to fool the discriminator with improved responses or attributes and the discriminator seeks to improve its detection of unconvincing responses, and thus improve its classification model. Over time, the GAN architecture may refine its ability to recognize convincing or unconvincing responses and may adjust its responses such that the conversational agent 120 is more convincing to the phisher, which may increase the likelihood of the phisher revealing useful data behind the intent or identification of the phisher or any data that may be used to investigate the attack and prevent future phishing attacks.

Additionally, a reinforcement learning model may be used to refine the conversational agent 120 in the exchange with the phisher. Reinforcement learning is the training of machine learning models to make a sequence of decisions. An artificial intelligence (AI) agent may learn to achieve a goal in an uncertain, potentially complex environment. In reinforcement learning, the AI may face a game-like situation where trial and error may be employed to come up with a solution to the problem. To achieve a desired result, the AI may earn either rewards or penalties based on the sequence of actions, with the goal of maximizing the total reward. Although a designer sets the reward policy, or the rules of the game, that designer gives the model no hints or suggestions for how to solve the game. The AI must figure out how to perform the task to maximize the reward, starting from completely random trials, as in the output of the generator, and evolving toward more sophisticated responses, as explained with respect to the GAN. Through this technique, the behavior of the AI may be refined quite accurately because the AI may conduct thousands of simultaneous gameplays in a training phase. Examples of reinforcement learning algorithms may include Q-learning, State-action-reward-state-action (SARSA) or Monte Carlo algorithms.

In the example of Q-learning, an agent may determine the best action to take strictly based on the current state of the agent. This type of reinforcement learning is known as “model-free” and “off-policy”. The objective in Q-learning is to find the best course of action given a current state and therefore, the agent may develop a set of rules autonomously or may operate outside a policy that may have come from a designer, which may be described as “off-policy.” As for “model-free”, an agent may use predictions of an expected response, or more specifically the response of the phisher, to move forward. This means the agent does not use a reward system to learn, but rather trial and error.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service’s provider.

Broad network access: capabilities are available over a network and accessed through standard mechanisms that promote use by heterogeneous thin or thick client platforms (e.g., mobile phones, laptops, and PDAs).

Resource pooling: the provider’s computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider’s applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

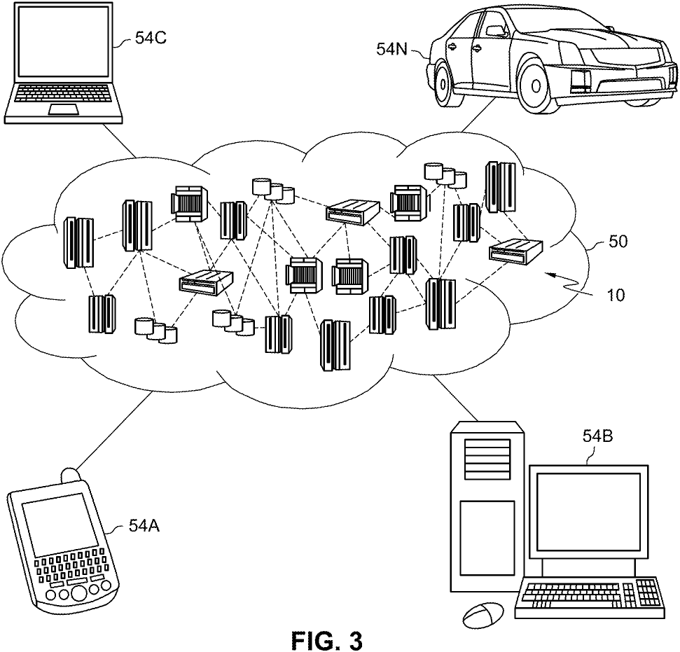

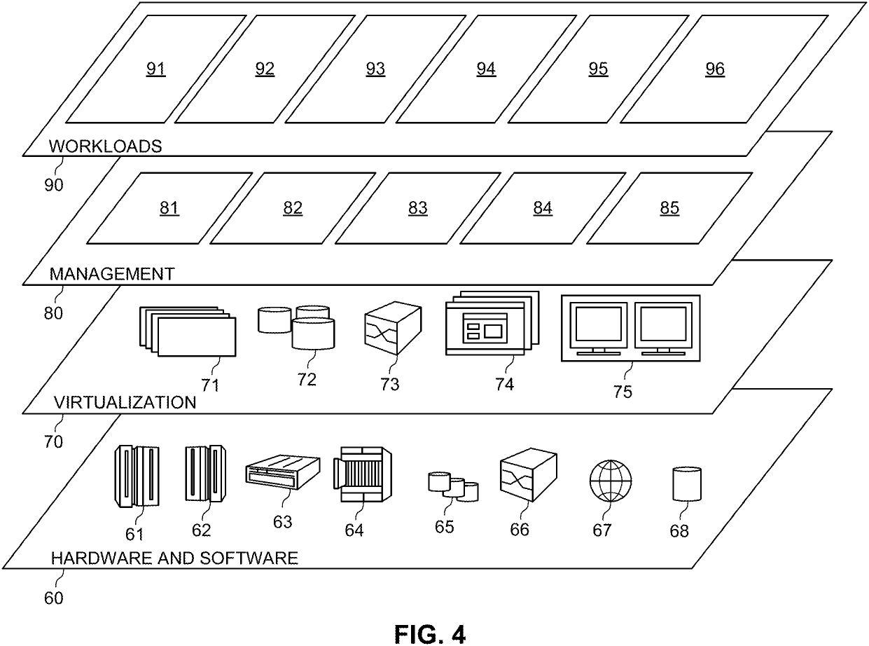

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66, such as a load balancer. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include mapping and navigation 91; software development and lifecycle management 92; virtual classroom education delivery 93; data analytics processing 94; transaction processing 95; and malicious email processing 96, which may refer to creating and maintaining a conversational agent that may pose as a human user for the purpose of determining intent of a phisher or extracting identifying or incriminating data from a phisher.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for using artificial intelligence (AI) to extract information from a phisher, the method comprising:
identifying a malicious email on a server, wherein the malicious email comprises an attempt by the phisher to compromise a user;
generating an automated conversational agent that poses as the user;
transmitting a message to the phisher by the automated conversational agent, wherein the message indicates that the user has been compromised;
receiving a response from the phisher; and
determining an intent of the phisher based on the response.

2. The computer-implemented method of claim 1, further comprising:
receiving personal data from the user; and
updating the automated conversational agent based on the personal data.

3. The computer-implemented method of claim 1, wherein a generative adversarial network (GAN) is used to generate the automated conversational agent.

4. The computer-implemented method of claim 1, further comprising:
determining an effectiveness of the message that is transmitted by the automated conversational agent based on the response from the phisher; and
updating the automated conversational agent based on the effectiveness of the message.

5. The computer-implemented method of claim 4, wherein a reinforcement learning algorithm is used to update the automated conversational agent based on the effectiveness of the message that is transmitted by the automated conversational agent.

6. The computer-implemented method of claim 4, further comprising:
displaying the message that is transmitted by the automated conversational agent to an expert user;
receiving a rating from the expert user; and
updating the effectiveness of the message based on the rating from the expert user.

7. The computer-implemented method of claim 1, wherein a machine learning classification model that determines an intent of a participant in a conversation from transmissions of the participant is used to determine the intent of the phisher.

8. A computer system for using artificial intelligence (AI) to extract data by engaging a phisher in conversation, comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
identifying a malicious email on a server, wherein the malicious email comprises an attempt by the phisher to compromise a user;
generating an automated conversational agent that poses as the user;
transmitting a message to the phisher by the automated conversational agent, wherein the message indicates that the user has been compromised;
receiving a response from the phisher; and
determining an intent of the phisher based on the response.

9. The computer system of claim 8, further comprising:
receiving personal data from the user; and
updating the automated conversational agent based on the personal data.

10. The computer system of claim 8, wherein a generative adversarial network (GAN) is used to generate the automated conversational agent.

11. The computer system of claim 8, further comprising:
determining an effectiveness of the message that is transmitted by the automated conversational agent based on the response from the phisher; and
updating the automated conversational agent based on the effectiveness of the message.

12. The computer system of claim 11, wherein a reinforcement learning algorithm is used to update the automated conversational agent based on the effectiveness of the message that is transmitted by the automated conversational agent.

13. The computer system of claim 11, further comprising:
displaying the message that is transmitted by the automated conversational agent to an expert user;
receiving a rating from the expert user; and
updating the effectiveness of the message based on the rating from the expert user.

14. The computer system of claim 8, wherein a machine learning classification model that determines an intent of a participant in a conversation from transmissions of the participant is used to determine the intent of the phisher.

15. A computer program product for using artificial intelligence (AI) to extract data by engaging a phisher in conversation, comprising:
a computer readable storage device having program instructions embodied therewith, the program instructions executable by a processor to cause the processor to perform a method comprising:
identifying a malicious email on a server, wherein the malicious email comprises an attempt by the phisher to compromise a user;
generating an automated conversational agent that poses as the user;
transmitting a message to the phisher by the automated conversational agent, wherein the message indicates that the user has been compromised;
receiving a response from the phisher; and
determining an intent of the phisher based on the response.

16. The computer program product of claim 15, further comprising:
receiving personal data from the user; and
updating the automated conversational agent based on the personal data.

17. The computer program product of claim 15, wherein a generative adversarial network (GAN) is used to generate the automated conversational agent.

18. The computer program product of claim 15, further comprising:
determining an effectiveness of the message that is transmitted by the automated conversational agent based on the response from the phisher; and
updating the automated conversational agent based on the effectiveness of the message.

19. The computer program product of claim 18, wherein a reinforcement learning algorithm is used to update the automated conversational agent based on the effectiveness of the message that is transmitted by the automated conversational agent.

20. The computer program product of claim 15, wherein a machine learning classification model that determines an intent of a participant in a conversation from transmissions of the participant is used to determine the intent of the phisher.
